(19) United States
(12) Patent Application Publication
(10) Pub. No.: US 2002/0085454 A1
(43) Pub. Date: Jul. 4, 2002

(54) Time period setting structure of timer

(75) Inventor: Albert Stekelenburg, Taipei (TW)

Correspondence Address: DOUGHERTY & TROXELL, SUITE 1404, 5205 LEESBURG PIKE, FALLS CHURCH, VA, 22041, US

(73) Assignee: All-Time Inc.

(21) Appl. No.: 09/767,729

(22) Filed: Jan. 24, 2001

(30) Foreign Application Priority Data
Jan. 4, 2001 (TW) 90200117

(51) Int. Cl. G04F 8/00; G04F 10/00

(52) U.S. Cl. 368/107

(57) ABSTRACT

The present application is to provide a time period setting structure of timer, in which a rotary disk is provided on periphery of setting disk, a transparent fixing cover and several setting keys are provided in the setting disks a LCD is also provided in the transparent fixing cover, and a rotary ringed stand is provided under the rotary disk, several projecting teeth are provided on the outer edge of ringed body under the ringed stand, otherwise, a sliding device is provided on base, a projecting tooth is provided on the sliding device; when the rotary disk is clockwise/ counter clockwise rotated, to-and-fro movement between left/right and central position is formed by means of rotating the projecting teeth under the ringed stand with fitting the projecting tooth of the sliding device, with which to-and-fro movement triggers conductor area of pre-set circuit, the object of setting Hour/Minute can be therefore achieved by operating the rotary disk.

### FIELD AND BACKGROUND OF THE INVENTION

The present application relates to time period setting device of a timer, with which several pre-set time period can be set, the position ON/OFF of circuit is changed in these time period; the present application denotes especially a device for setting “Hour” and “Minute”.

There are many setting mode of conventional timer in the market, such as mechanical (setting via stirring keyboard is general) and electronic (using key controlling), i.e. there are a variety of timer; basically, mechanical setting is an easier setting, but the divide of each time period is larger, in other words, which can only make a coarse setting time period; and for electronic setting the usable space on the setting disk is not large, because there are many keys therein, the man who not knows the operation well or whose finger is coarse makes easily an erroneous setting, and it's more difficult in operation. The present application is an electronic timer, for smaller numeral change, such as setting ON/OFF, setting switching timing/present time, “week X” etc., which are controlled by the keys, and for two larger numeral change, such as “Hour X ” and “Minute X”, which are set by means of rotating rotary disk mode, the object of correct setting can be easily achieved.

### SUMMARY OF THE INVENTION

The object of the present application is to provide a device for setting the time period; its general condition is as below:

1. function: setting time ON/OFF for several groups timing 1-7 days,

2. Program mode: divided into displaying present time (clock) and setting time period,

3. Explaining the function of keys:

a. Clock mode-displaying present time mode,

(a-1) key “ON/OFF”: switching ON/OFF output,

(a-2) key “Clock +Day”: regulating present week (MO-SU),

(a-3) key “Clock” +rotary disk rotated clockwise: regulating “Hour” for present time,

(a-4) key “Clock” +rotary disk rotated counter clockwise: regulating “Minute” for present time,

(a-5) key “Timer”: entering into program mode,

*under clock mode, key “Day” and rotary disk are clock wise/counter clockwise rotated, alone use will be without function, the function to be produced must match key “Clock”,

b. program mode: setting time mode,

(b-1) key “ON/OFF”: without function,

(b-2) key “Day”: regulating day (of week) of timer ON/OFF, there are 11 settings for date, such as MO, TU, WE, TH, FR, ST, SU, MO-FR, SA-SU, MO-SA, MO-SU,

(b-3) rotary disk rotated clockwise: setting time “Hour” of timing function,

(b-4) rotary disk rotated counter clockwise: setting time “Minute” of timing function,

(b-5) key “Timer” ON/OFF time setting switching (1 ON→1 OFF→2 ON→ . . . →6 OFF) of 6 groups ON/OFF for timing function,

(b-6) key “Clock”: returning clock mode,

c. key “Reset”: all memories are cancelled when the key “Reset” is depressed whether it is under clock or program mode, and the program is again started.

As above-mentioned, the characteristics of present application is to provide a structure setting “Hour X” and “Minute X”, in which setting Hour/Minute is operated by clockwise or counter clockwise rotation, without the necessity for setting too much keys on a dial, the position such as erroneous trigger etc. produced at the time setting “Hour” and “Minute” of larger numeral change can be avoided. The technical solution of the present application is in that, a rotary disk is provided in the outer edge, a ringed structure having several projecting teeth is driven by rotating the rotary disk, and a sliding structure which can be moved to right/left by stirring the projecting tooth, a contact structure of breaking over circuit is provide on the sliding structure, the Hour/Minute can be quickly set by means of contact (producing pulse) time on the special area of circuit board for the structure.

The circuit part of timer in present application will be no more described because which belongs to conventional technical, and is not claimed in present application.

### BRIEF DESCRIPTION OF THE DRAWINGS:

FIG. 1 is a perspective view of present application,

FIG. 2 is a vertical view of present application;

FIG. 3 is an exploded view of elements of present application;

FIG. 4 is a schematic view illustrating a mating position of rotary ringed stand and sliding device;

FIG. 5 is a schematic view of a second circuit board;

FIG. 6 is a schematic view of sliding device under normal position;

FIG. 7 is a schematic view (I) of sliding device under breaking over position;

FIG. 8 is a schematic view(II) of sliding device und breaking over position.

### DETAILED DESCRIPTION OF A PREFERRED EMBODIMENT

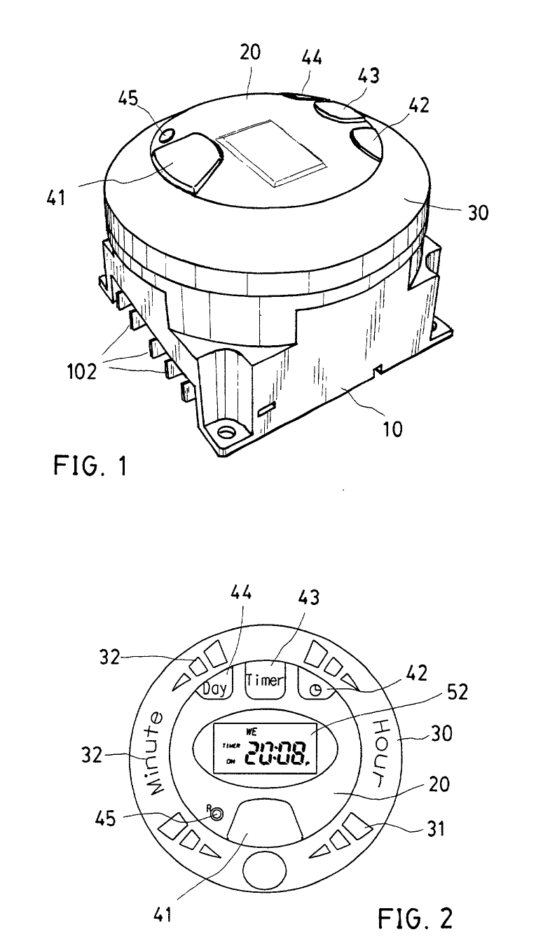

As shown in FIG. 1, there is a transparent fixing cover 20 on a housing 10, and there is a rotary disk on circumference of the fixing cover 20, several keys 41, 42, 43, 44, 45 are provided on the fixing cover 20.

As shown in FIG. 2, every displays on the LCD displaying board 53 can be seen by the eye from the transparent fixing cover 20 there under; marks 31, 32 are printed on the rotary disk 30, in order to inform to user the rotating direction and its function; wherein

key 41 is key “ON/OFF”;

key 42 is key “Clock”;

key 43 is key “Timer”;

key 44 is key “Day”;

key 45 is key “Reset”.

Increasing number of “Hour” can be controlled when the rotary disk 30 is clockwise rotated, and increasing number of “Minute” can be controlled when the rotary disk 30 is counter clockwise rotated, all of which must be mated with key 42.

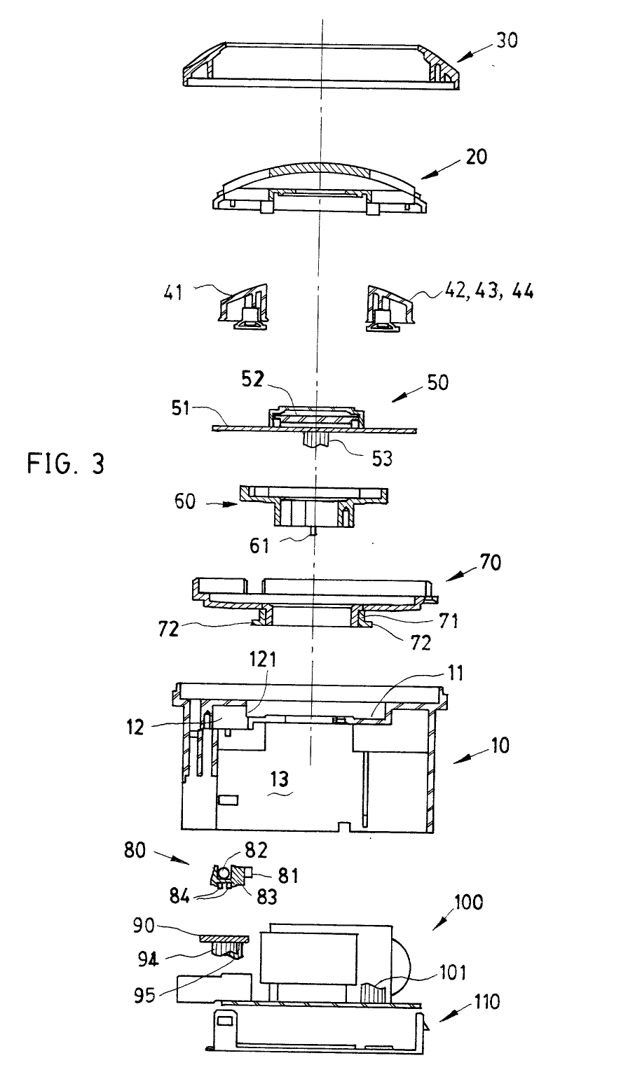

As shown in FIG. 3, the structure of present application includes also a first circuit board 50, a receiving stand 60, a rotary ringed stand 70, a sliding device 80, a second circuit board 90, a third circuit board 100 and a base 110, except that which contains a housing 10, a fixing cover 20, a rotary disk 30 and keys 41, 42, 43, 44, 45.

The receiving stand 60 above housing 10 is fixed by inserted pin 61, the rotary ringed stand 70 above housing 10 is provide in the ringed recess 11, the sliding device 80 in one side of the housing is provided in sliding recess 12, the second circuit board 90 and the third circuit board 100 are provided in the space 13, under the housing 10 is connected with base 110.

The fixing cover 20 is a structural body of transparent material, which has respective through holes 21, 22 etc. provided for each keys 41, 42, 43, 44, 45 (each key has a respective through hole, which is not entirely shown in the drawing); under fixing cover 20 is connected with first circuit board 50.

The first circuit board 50 is a conventional device, the LCD displaying board 52 is provided on the circuit board 51, in order to display the present time or a setting time period; the receiving stand 60 is downwards connected with first circuit board 50, and is upwards connected with fixing cover 20, and the bus 53 of its circuit is connected with second circuit board 90.

Under receiving stand 60 is passing through the inner side of the rotary ringed stand, which is provided on the housing 10 by inserted pin 61 or screw.

The rotary disk 30 and the rotary ringed stand 70 are integrated by clip or screw etc., both inner receive above-mentioned fixing cover 20, keys 41, 42, 43, 44, 45, first circuit board 50 and receiving stand 60 etc.; the rotary ringed stand 70 is provided on the recess 11, several projecting teeth are provided on the ringed body 71 under the rotary ringed stand 70.

A sliding recess 12 is provided on the housing 10, in order to provide sliding device 80, wherein the projecting tooth 81 of sliding device 80 projects from side opening 121 of sliding recess 12, and the projecting teeth 72 of rotary ringed stand 70 are mated with the projecting tooth 81 of sliding device 80, in order to use for setting increasing “Hour” and increasing “Minute”.

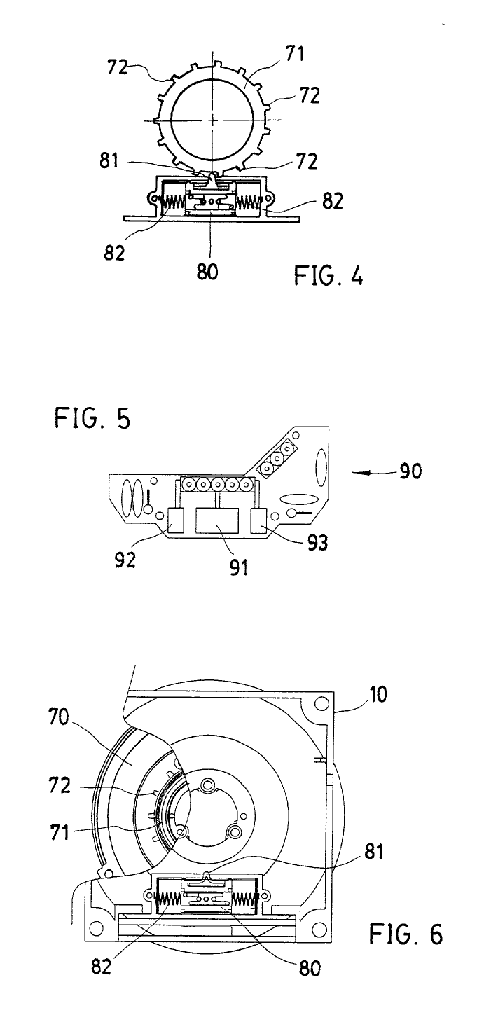

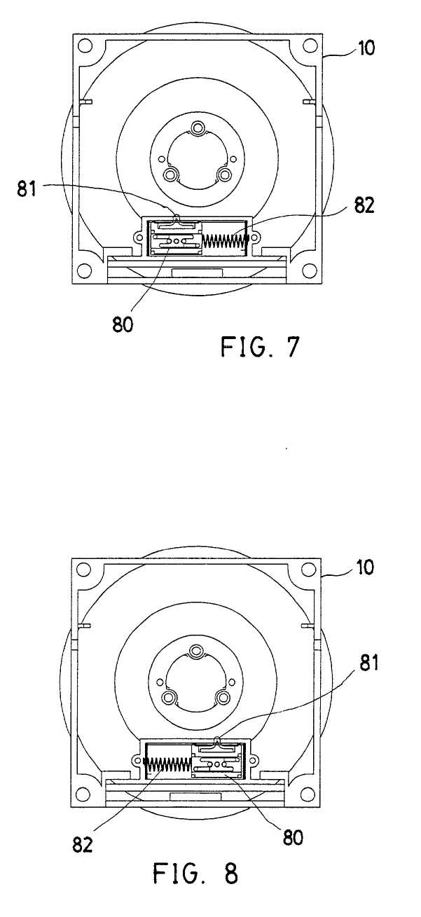

As shown in FIG. 4, stirring the projecting teeth 72 makes the projecting tooth 81 move leftwards when the ringed body 71 is clockwise rotated, the projecting tooth 81 makes sliding device 80 slide back to central position, which is due to restoring force of spring 82, when the action is up to that the projecting teeth 72 are apart from the projecting stirring scope of the projecting tooth 81; the next projecting teeth 72 will be again stirred, which makes the projecting tooth 81 move again leftwards, if the ringed body 71 is continuously clockwise rotated ( please reference to FIG. 7).

As above-mentioned, stirring the projecting teeth 72 makes the projecting tooth 81 move rightwards, when the ringed body 71 is counter clockwise rotated, the projecting tooth 81 makes sliding device 80 slide back to central position, which is due to restoring force of spring 82, when the action is up to that the projecting teeth 72 are apart from the projecting scope of the projecting tooth 81; the next projecting teeth 72 will be again stirred, which makes the projecting tooth 81 move again rightwards, if the ringed body 71 is continuously counter clockwise rotated (please reference to FIG. 8).

In other words, clockwise/ counter clockwise rotating the rotary disk will make the sliding device 80 move from central to left/right as to-and-fro movement.

In FIG. 4, the sliding device 80 is provided in a tangential position of ringed body 71, its constitution includes a contact device 84 provided under the housing 83, which is used for conducting the conductor area of second circuit board 90.

As shown in FIG. 5, which is a schematic view of second circuit board 90, wherein three conductor areas 91, 92, 93 are provided thereon, the position of the contact device 84 when which is not stirred (leftward/ rightward move) is between three conductor areas 91, 92, 93, i.e. three conductor areas 91, 92, 93 and the contact device 84 are in conducting position (conducting position of “increasing Hour”), when the contact device 84 is stirred and is leftwards moved, the conductor areas 91, 93 and the contact device 84 are in conducting position ( conducting position of “increasing Minute”), when the contact device 84 is stirred and is rightwards moved; utilizing above-mentioned leftward/ rightward movement conducts respectively different conductor areas, which makes circuit increasing setting number of Hour/ Minute, which is produced due to the conducting time.

As shown in FIG. 6, the sliding device 80 is in normal position (without increasing “Hour”, without increasing “Minute”). As shown in FIG. 7, the sliding device 80 is in left position, which can make setting for increasing Hour. As shown in FIG. 8, the sliding device 80 is in right position, which can make setting for increasing Minute.

The third circuit board 100 in FIG. 3 is via bus 101 connected with bus 94 of the second circuit board 90 (bus 94, 101 are same bus), bus 95 and bus 53 are same bus, several connectors 102 are provided on the third circuit board 101 (please reference to FIG. 1), which conduct respectively input circuit and output circuit.

In summary, the timer of present application can make the circuit functional, which has function setting “Hour/Minute”, by means of controlling the rotary disk provided in outer edge of dial, which is clockwise/counter clockwise rotated and its function can be further displayed on LCD displaying board 52, the setting position can be seen by eye.

1. A time period setting structure, its constitution includes:
a setting disk includes a transparent fixing cover and several keys, its circumference provides a rotary disk, a LCD provided there under, several through holes provided on the setting disk, in order to provide setting of key “ON/OFF”, key “Clock”, key “Timer”, key “Day” and key “Reset”; a first circuit board provided under setting disk, LCD provided on circuit board;
a rotary disk provided in outer edge of setting disk, and connected With rotary ringed stand there under;
a housing fixes receiving stand thereon, rotary ringed stand provided on the receiving stand; sliding device provided in sliding recess located in one side of housing; second circuit board and third circuit board are provided with space there under, base and housing provide connection;
a rotary ringed stand connected with setting disk, a ringed body provided there under several projecting teeth provided thereon; a sliding device provided in tangential position of ringed body, its constitution includes a projecting tooth and spring etc., the projecting tooth is mated with the projecting teeth of ringed body, the housing of sliding device produces transversally to-and-fro movement, when ringed body is rotated; contact device is provided on the sliding device and is mated with second circuit board;
a second circuit board provides three conductor areas thereon, and forms triggered device of “normal position” and “increasing Hour”, “increasing Minute” in circuit;
characterized in that, the housing of sliding device is as to-and-fro leftwards/rightwards rotated by rotating the projecting teeth of ringed stand, when the setting disk is clockwise/counter clockwise rotated, the time period setting structure of timer is formed by means of mating contact device on housing with conductor areas of second circuit board, with which the circuit is controlled for setting Hour/Minute.
